(19) United States
(12) Patent Application Publication
(10) Pub. No.: US 2014/0142854 A1
(43) Pub. Date: May 22, 2014

(54) METHOD FOR LOCATING A MICROSEISMIC EVENT

(71) Applicant: CONOCOPHILLIPS COMPANY, Houston, TX (US)

(72) Inventors: Samik SIL, Houston, TX (US); Ulrich ZIMMER, Spring, TX (US); Michael DAVIDSON, Houston, TX (US)

(73) Assignee: CONOCOPHILLIPS COMPANY, Houston, TX (US)

(21) Appl. No.: 14/081,043

(22) Filed: Nov. 15, 2013

Related U.S. Application Data
(60) Provisional application No. 61/727,314, filed on Nov. 16, 2012.

(51) Int. Cl. G01V 1/28

(52) U.S. Cl. CPC G01V 1/288
USPC 702/6

(57) ABSTRACT

A method of event location to avoid first break picking when signals are small or the ambient noise level is high is described. In this method traveltime associated with the maximum amplitude phases (for any mode of wave) are identified and picked from one or more sensors in an array. Difference between the arrival times are then calculated. A grid search (or optimization) techniques are then employed to search for the event location to match the observed time differences.

### CROSS-REFERENCE TO RELATED APPLICATIONS

This application is a non-provisional application which claims benefit under 35 USC §119(e) to U.S. Provisional Application Ser. No. 61/727314 filed Nov. 16, 2012, entitled “METHOD FOR LOCATING A MICROSEISMIC EVENT,” which is incorporated herein in its entirety.

### FIELD OF THE INVENTION

This invention relates generally to monitoring of subterranean formation and, more particularly, to systems and methods for locating microseismic event.

### BACKGROUND OF THE INVENTION

Monitoring of induced microseismic events is an important tool in hydraulic fracture diagnostics and understanding fractured reservoirs in general. In particular, maps of microseismic event locations in three-dimensional space have become an essential part of understanding induced hydraulic fracture patterns in unconventional resource plays. A microseismic event is typically several magnitudes weaker than a felt earthquake but still may be recorded from thousand(s) of feet away. These events are characterized by various waves (e.g., body waves, surface waves, etc.) which can displace water and/or Earth particles as the waves propagate. In particular, body waves include primary wave (P-wave) and secondary wave (S-wave). P-wave is a compressional wave that move particles in the direction of wave propagation. S-wave is usually slower than P-wave and move through solid rock. S-waves typically move particles perpendicular to the direction of wave propagation. Accuracy of microseismic event locations primarily determines the overall value of the microseismic map.

In a conventional single well monitoring system, first break times of seismic waves (Primary “Tₚ” and Secondary “Tₛ”) are picked for locating a microseismic event. Typically, microseismic signals are detected with sensor arrays installed either on the surface, in shallow (depth less than 2,000 feet) boreholes, or in deep boreholes drilled (close) to the target formation. To locate a detected event, it is often necessary to identify the arrival of the P- and S-wave phases. These picked arrival times can be compared with theoretical arrival times from all possible event locations (typically on a grid) calculated using a known velocity model. By comparing the picked arrival times with the theoretical arrival times, the grid point with the best match can be identified and is considered the most likely event location.

In addition to the arrival times, a complete event localization may require evaluation of particle motion, especially if linear sensor arrays of limited extension are used. Overall, some traditional methods rely heavily on the accurate identification of the arrival times of P- and S-waves. However, selecting P- and S-wave first breaks can be relatively difficult when the signals are small or if ambient noise level is high.

Therefore, a need exists for selecting first breaks when signals are small or the ambient noise level is high. Alternatively, a method can locate microsismic events while avoiding first break picking

### SUMMARY OF THE INVENTION

This invention relates generally to monitoring of subterranean formation and, more particularly, to systems and methods for locating microseismic event

One embodiment of the present invention provides a method of locating a microseismic event that includes picking a microseismic signal on a first sensor of a sensor array for one or more mode of wave; identifying arrival times of the microseismic signal on a second sensor of the sensor array; determining the arrival time differences between the first and second sensor; and performing a grid search/optimization using an objective function designed to handle arrival time differences.

Another embodiment of the present invention provides a method for locating a microseismic event that includes picking a large amplitude phase arrival on a first sensor of a sensor array for one or more mode of wave; identifying arrival times of the large amplitude phase on a second sensor of the sensor array; determining one or more arrival time differences between the first and second sensors; and performing a grid search and optimization using an objective function designed to handle arrival time differences throughout the sensor array for microseismic event location.

### BRIEF DESCRIPTION OF THE DRAWINGS

The invention, together with further advantages thereof, may best be understood by reference to the following description taken in conjunction with the accompanying drawings in which:

FIG. 1 depicts an example geometry of the geophone locations and event locations in accord with an embodiment of the present invention.

FIG. 2 depicts the plot of the observed times of maximum amplitudes recorded in seven geophones in accord with an embodiment of the present invention.

FIG. 3 depicts the horizontal slices of the possible event location, in accord with an embodiment of the present invention.

FIG. 4 depicts the stack of all six slices in a vertical plane, in accord with an embodiment of the present invention.

FIG. 5 illustrates a map view of located acoustic emission events, in accord with an embodiment of the present invention.

FIG. 6 illustrates a map view of located acoustic emission events, in accord with an embodiment of the present invention.

### DETAILED DESCRIPTION OF THE INVENTION

Reference will now be made in detail to embodiments of the present invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For instance, features illustrated or described as part of one embodiment can be used in another embodiment to yield a still further embodiment. Thus, it is intended that the present invention cover such modifications and variations that come within the scope of the appended claims and their equivalents.

The present invention provides systems and methods for locating microseismic events. In some embodiments, the microseismic events may be induced by geological activities such as hydraulic fracturing. One embodiment of the present invention provides the steps of (1) picking of a clear P-wave (T_{Pmax}) and/or S-waves (T_{Smax}.) phase arrival in the wavelet on one sensor and identifying the same phase arrival in another sensor signals and (2) using the differences between the picked arrival times of a certain phase between sensors as an input for the event localization grid search. In some embodiments, the arrival time may be based on the large amplitude time, maximum amplitude time, first arrival time (first break picker), and the like. This method can return better results compared to some conventional methods for microseismic event location. Other advantages will be apparent from the disclosure herein.

Microseismic event location techniques can involve selecting P- and S-wave first breaks (T_{P} and T_{S}), which may be difficult and/or inaccurate. By selecting a large phase arrival wavelet and identifying the same phase arrival in another sensor signals, more reliable measurements of the traveltime differences between the phase arrivals are possible. Furthermore, changing the object function that measures match between selected and theoretical arrival times to only use traveltime differences between the identified picks, can overcome other measurements concerns.

In order to detect microseismic event locations according to one or more embodiments, the following method is disclosed. For an n number of geophones in a sensor array, a large amplitude phase arrival in one sensor is first selected. Next, the arrival time of the large amplitude phase arrival in a second sensor from the same event is identified. Typically, selecting the amplitude from all the geophones is not necessary; however, selection from at least two geophones should occur. Once the large amplitude phase arrivals are detected in the sensors, difference between the two selected arrival times can be calculated. The difference can be taken in any order or combination, e.g., the first geophone and the second geophone, the second geophone and the third geophone, the first and the last geophone, the second geophone and the penultimate geophone, etc.).

In accordance with one or more embodiments, a suitablevelocity model may be derived from, for example, well log, active seismic data, perforation shot and the like. Using this velocity model, a grid search/optimization may be performed using an object function designed to handle arrival time differences throughout the sensor array rather than absolute arrivals. Depending on the geophone geometries and velocity model, further polarization analysis (e.g. hodogram analysis to determine arrival angle) may be required for the redefinition of the event location.

### EXAMPLE 1

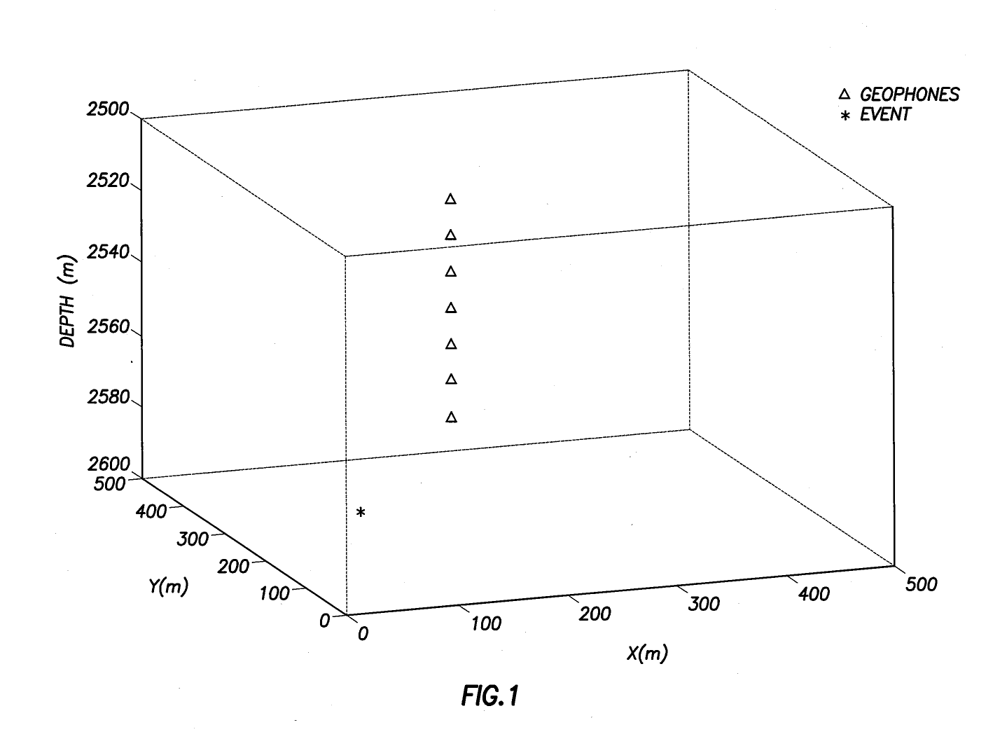

In this example, homogeneous medium with one vertical sensor array is considered. As shown in FIG. 1, the sensor array consists of 7 geophones located at x=150 meters and y=150 meters. In some embodiments, the array may be a geometrical shape selected from the group consisting of: a line, a cross, a square, a circle, a rectangle, and any combination thereof. While this example shows an embodiment having 7 sensors, this is not intended to be limiting. Other embodiments may have more than 7 sensors in an array, for example, 8 to 20 or more. In some embodiments, multiple sensor arrays may be used.

The top sensor is located at a depth of 2,500 meters and the bottom sensor is located at a depth of 2,560 meters. The depth increment between sensors is a constant 10 meters. An event is located at x=50 meters, y=100 meters and z=2,580 meters. The sensor arrays may have other geometries such as having different depth increments between the sensors (e.g., 5 meters, 15 meters, 20 meters, 30 meters, etc.). In other embodiments, the sensors may be spaced at non-constant intervals. FIG. 1 also show the event location in relation to the geophones.

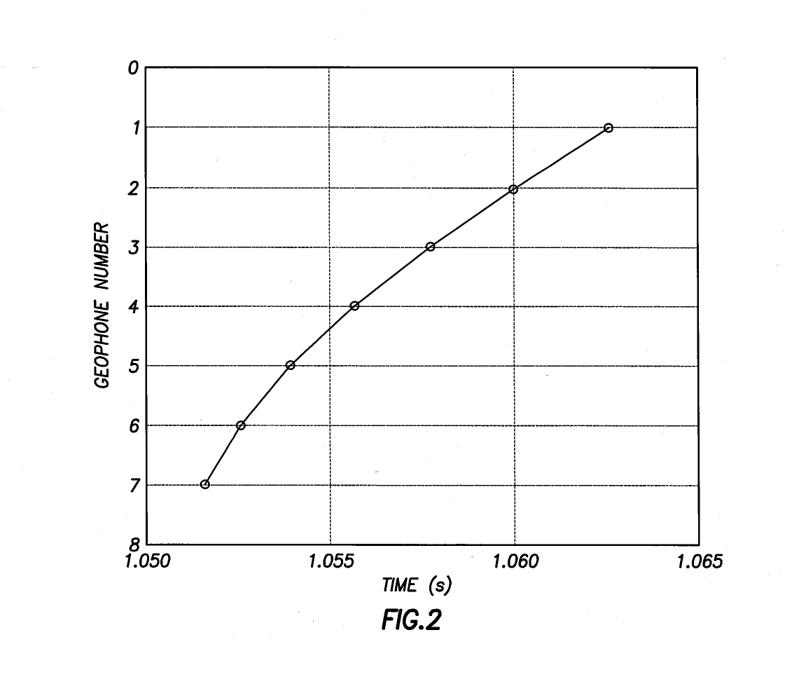

FIG. 2 shows a plot of the observed times of maximum P-wave amplitudes recorded in the 7 geophones. As expected, the observed times increases further away from the event location. Six time differences ΔT_{Pmax} . were calculated by taking the difference in observed times. Specifically, the calculated observed time were between (i) geophone 7 and geophone 6; (ii) geophone 6 and geophone 5; (iii) geophone 5 and geophone 4; (iv) geophone 4 and geophone 3; (v) geophone 3 and geophone 2; and (vi) geophone 2 and geophone 1. These differences are shown as examples. The differences may be taken in any order and for any other wave modes.

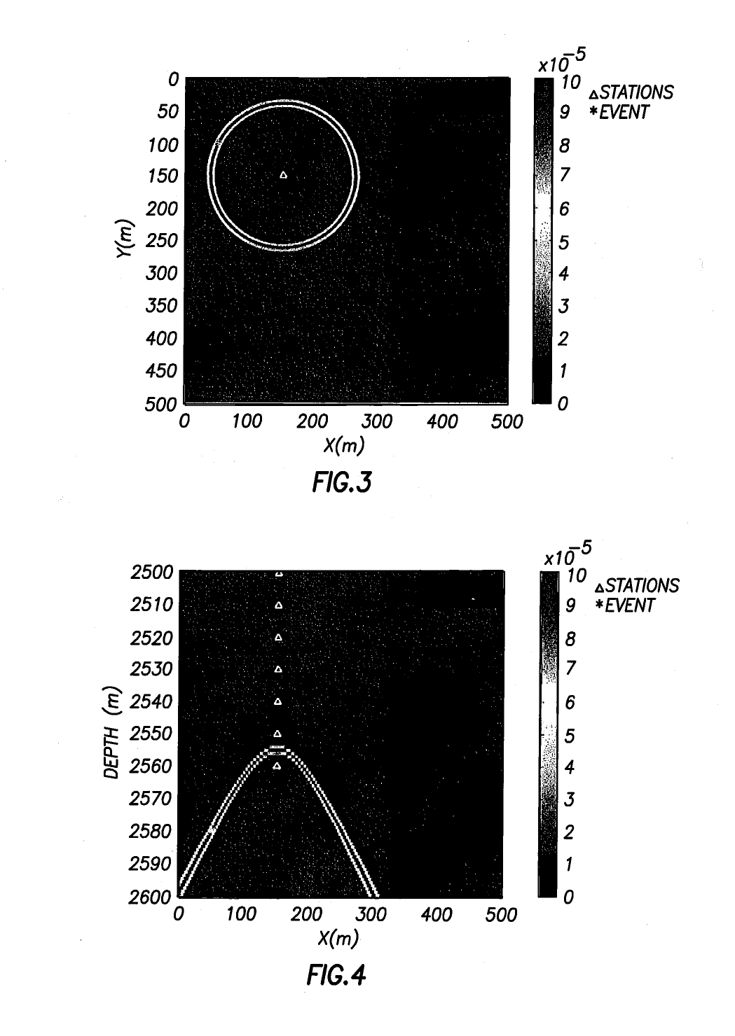

Next, a grid search for all six values of ΔT_{Pmax} was performed. FIG. 3 shows the horizontal slices of the possible event location. The possible event location forms a circular pattern in the horizontal slices. FIG. 4 shows the stack of all six slices in a vertical plane.

A similar analysis can be made using time differences of S-wave maximum amplitude Moreover, P- and S-wave maximum amplitude differences from different geophones combinations may be used.

Instead of using a manual grid search, other suitable optimization or inversion (e.g. conjugate gradient) scheme can also be applied to perform the event location in both the conventional and present method. By way of comparison, the objective function constructed as a probability density function (PDF) using a conventional approach is shown below.

$$PDF ( {t}_{m} - {t}_{c} ) = exp \{ \frac{1}{M} \sqrt{\frac{{\sum }_{i} {[ {t}_{m}^{i} - {t}_{c}^{i} - \frac{1}{M} ( {t}_{m}^{i} - {t}_{c}^{i} ) ]}^{2}}{{σ}_{m}^{2} + {σ}_{c}^{2}}} \} \qquad ( 1 )$$

where m is the measured parameter or selected arrival (first break) time; c is the calculated (or theoretical) arrival (first break) time; M is the number of selected phase arrivals; and i is the enumerator for the selected arrival times; σₘ and σ_{c} are standard deviations for the measured and calculated (c) traveltimes respectively assuming a normal distribution for measured and calculated traveltimes.

The objective function using the proposed approach using P-wave time differences, S-wave time differences and P and S-wave time differences (i.e. PDF^{(p)}, PDF^{(S)}, PDF^{(PS)} is shown below in equations 2, 3 and 4 respectively.

$$\begin{matrix}{PDF}^{( P )} ( Δ {t}_{m} - Δ {t}_{c} ) = exp \{ \frac{1}{M - 1} \sqrt{{\sum }_{i = 2}^{M} \frac{{[ ( {t}_{m}^{i} - {t}_{m}^{1} ) - ( {t}_{c}^{i} - {t}_{c}^{1} ) ]}^{2}}{{σ}_{m}^{2} + {σ}_{m}^{( 1 ) 2} + {σ}_{c}^{2} + {σ}_{c}^{( 1 ) 2}}} \} & ( 2 ) \\ {PDF}^{( S )} ( Δ {t}_{m} - Δ {t}_{c} ) = exp \{ \frac{1}{N - 1} \sqrt{{\sum }_{i = 2}^{N} \frac{{[ ( {t}_{m}^{i} - {t}_{m}^{1} ) - ( {t}_{c}^{i} - {t}_{c}^{1} ) ]}^{2}}{{σ}_{m}^{2} + {σ}_{m}^{( 1 ) 2} + {σ}_{c}^{2} + {σ}_{c}^{( 1 ) 2}}} \} & ( 3 ) \\ PDF ( Δ {t}_{m} - Δ {t}_{c} ) = {PDF}^{( P )} ( Δ {t}_{m} - Δ {t}_{c} ) \cdot {PDF}^{( S )} ( Δ {t}_{m} - Δ {t}_{c} ) & ( 4 )\end{matrix}$$

Instead of using the difference of P- or S-wave arrival for different sensors as described in equations (2) and (3), it is also possible to use the difference of the P- and S-wave arrival of a single sensor provided that both arrival types are available. Equations (2) and (3) work for any phase arrival that is common to the sensors. This can be the arrival of the direct wave, the head-wave, a converted wave or a reflected wave. There is no assumption made as to what sensors are involved in the difference building. Any pair of sensors in the total acquisition array is allowed as long as the common phase arrivals are identified.

It is also possible to extend this method to the simultaneous localization of multiple events. Where the well-known double difference methods works with the traveltime differences between multiple events, the new method works with the differences of traveltime differentials between multiple events. The number of events involved in the simultaneous analysis is only limited by any stability criterion the user might want to impose on the overall extend of the cluster involved.

Besides a more accurate event location this method allows for a more reproducible identification of arrival times by using the first large amplitude arrival that is traceable throughout the sensor array.

### EXAMPLE 2

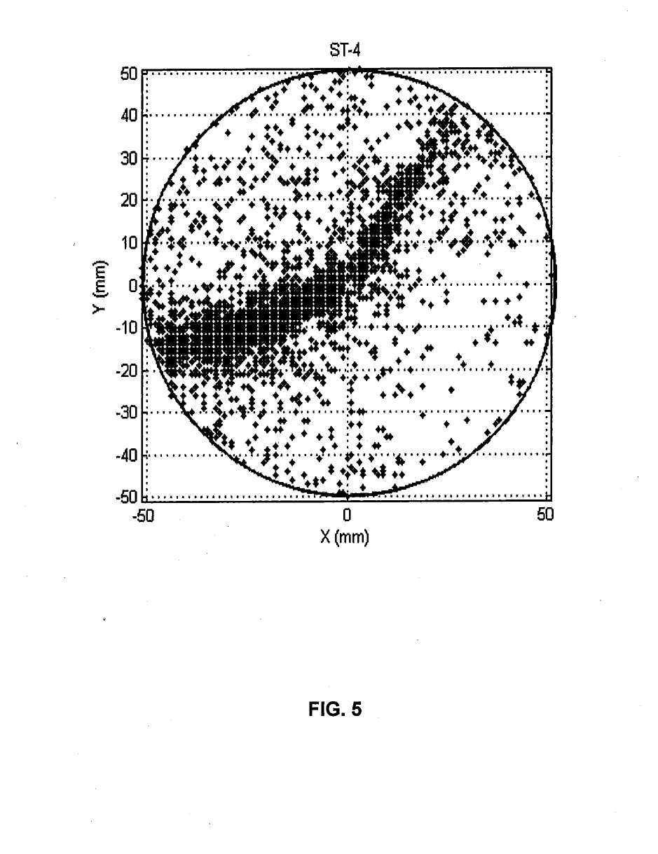

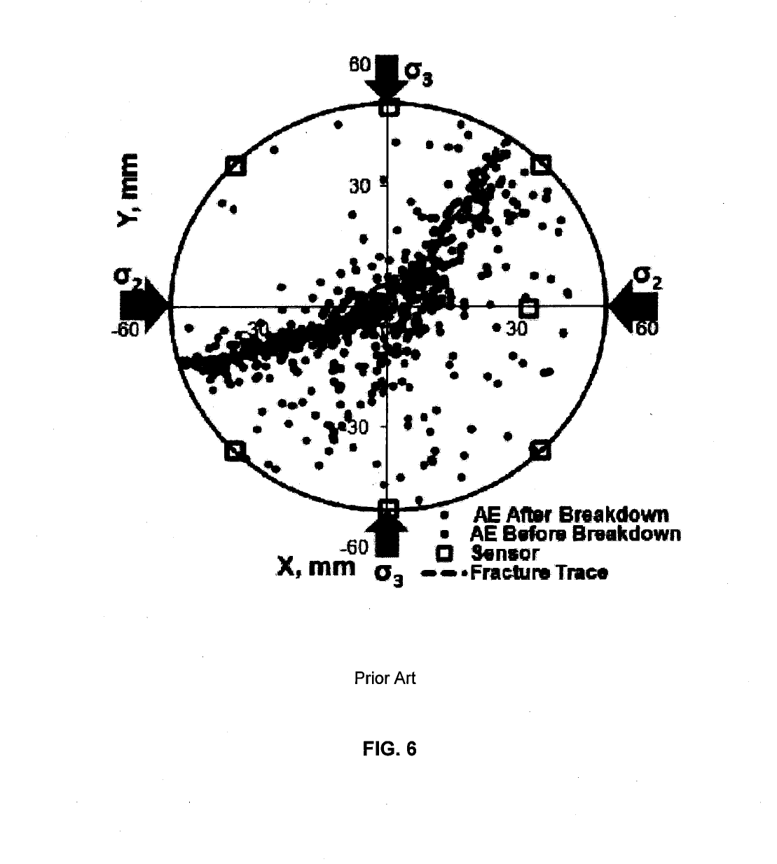

In this example, a method of the present invention was used to locate acoustic emission events using data obtained from a previously conducted laboratory experiment (Damani et al., 2012, the relevant parts of which are incorporated by reference). FIG. 5 shows a plot of located events using P-wave arrival only using a differential method of the present invention. More specifically, FIG. 5 shows a map view of the located acoustic emission events from Lyons Sandstone Triaxial Test 1 (sample ST-4 in Damani et al). For comparison, FIG. 6 is a map view of the located acoustic emission events by Damani et al. 2012 using a conventional method. This example shows that a method of the present invention determined more events with greater accuracy compared to a conventional method.

In closing, it should be noted that the discussion of any reference is not an admission that it is prior art to the present invention, especially any reference that may have a publication date after the priority date of this application. At the same time, each and every claim below is hereby incorporated into this detailed description or specification as an additional embodiment of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A method of locating a microseismic event comprising:
a. picking a microseismic signal on a first sensor of a sensor array for one or more mode of wave;
b. identifying arrival times of the microseismic signal on a second sensor of the sensor array;
c. determining one or more arrival time differences between the first and second sensors; and
d. performing a grid search and optimization using an objective function designed to handle arrival time differences for microseismic event location.

2. The method of claim 1, wherein the one or more mode of wave is selected from the group consisting of: P-wave, S-wave, and any combination thereof

3. The method of claim 1, wherein the sensor array is arranged in a geometrical shape selected from the group consisting of: a line, a cross, a square, a circle, a rectangle, and any combination thereof.

4. The method of claim 1, wherein the microseismic signal is a first recorded signal attributed to the microseismic event, a large amplitude phase arrival, or maximum amplitude arrival.

5. The method of claim 1, wherein the arrival time difference is determined between adjacent sensors on the sensor array.

6. The method of claim 1, wherein the sensor array comprises 2 to 20 sensors.

7. The method of claim 1, wherein the sensors array comprises sensors spaced apart at constant increment.

8. The method of claim 7, wherein the constant increment is selected from the group consisting of: 5 meters, 10 meters, 15 meters, 20 meters, and 30 meters.

9. The method of claim 1, further comprising one or more additional sensor arrays.

10. The method of claim 1, wherein the sensor arrays comprises sensors spaced at non-constant increments.

11. A method for locating a microseismic event, comprising:
a. picking a large amplitude phase arrival on a first sensor of a sensor array for one or more mode of wave;
b. identifying arrival times of the large amplitude phase on a second sensor of the sensor array;
c. determining one or more arrival time differences between the first and second sensors; and
d. performing a grid search and optimization using an objective function designed to handle arrival time differences throughout the sensor array for microseismic event location.

12. The method of claim 11, wherein the one or more mode of wave is selected from the group consisting of: P-wave, S-wave, and any combination thereof

13. The method of claim 11, wherein the sensor array is arranged in a geometrical shape selected from the group consisting of: a line, a cross, a square, a circle, a rectangle, and any combination thereof.

14. The method of claim 11, wherein the first or second sensor is a geophone.

15. The method of claim 11, wherein at least one arrival time difference is determined between adjacent sensors on the sensor array.

16. The method of claim 11, wherein the sensor array comprises 2 to 20 sensors.

17. The method of claim 11, wherein the sensors array comprises sensors spaced apart at constant increment.

18. The method of claim 17, wherein the constant increment is selected from the group consisting of: 5 meters, 10 meters, 15 meters, 20 meters, and 30 meters.

19. The method of claim 11, further comprising one or more additional sensor arrays.

20. The method of claim 11, wherein the sensor arrays comprises sensors spaced at non-constant increments.
